(19) United States
(12) Patent Application Publication
(10) Pub. No.: US 2010/0005804 A1
(43) Pub. Date: Jan. 14, 2010

(54) COMBUSTOR STRUCTURE

(75) Inventors: Wei Chen, Greer, SC (US); David Martin Johnson, Simpsonville, SC (US); Ronald James Chila, Greer, SC (US); Joseph Citeno, Greenville, SC (US)

Correspondence Address: CANTOR COLBURN, LLP, 20 Church Street, 22nd Floor, Hartford, CT, 06103, US

(73) Assignee: GENERAL ELECTRIC COMPANY, Schenectady, NY (US)

(21) Appl. No.: 12/171,386

(22) Filed: Jul. 11, 2008

(51) Int. Cl. F02C 1/00

(52) U.S. Cl. 60/752; 60/725

(57) ABSTRACT

A combustor includes at least one combustor liner defining a combustion chamber capable of directing combustion products toward a turbine. At least one combustor sleeve is located outside of the combustion chamber and is capable of reducing a magnitude of acoustic waves in the combustion chamber. The at least one combustor liner and the at least one combustor sleeve define at least one flow channel therebetween. Further, a combustor includes at least one combustor liner defining a combustion chamber capable of directing combustion products toward turbomachinery. At least one combustor sleeve disposed outside of the combustion chamber and is capable of controlling distribution of fluid flow in the combustor to modify a uniformity of the fluid flow to the combustion chamber.

### BACKGROUND

The subject invention relates to turbomachinery. More particularly the subject invention relates to combustor construction for a turbomachine.

In a typical turbomachine, for example, a gas turbine, a combustor converts chemical energy of a fuel or a fuel and air mixture into thermal energy. The thermal energy is conveyed by a fluid, often air from a compressor, to a turbine where the thermal energy is converted into mechanical energy. Many characteristics of the gas turbine impact the efficiency of these energy conversions. The characteristics include blade passing frequencies, fuel supply fluctuations, combustor head-on volume, fuel nozzle design, fuel air profiles, purge airflow, flame shape and flame stabilization. One example is a vibratory or acoustic frequency, blade passing frequency (BPF), produced at the exit of the compressor by a row of blades passing a row of stationary vanes at the compressor exit. This acoustic phenomena leads to variations and oscillations of pressure and temperature in the air provided to the combustor and subsequently gas turbine operability issues such as combustor lean blow out, combustor dynamics, increased emissions, and other gas turbine operability issues.

Combustor dynamics issues are typically addressed by applying one of the following: employing a resonator at the combustion chamber, adjustment of IGV angles, reprofiling of the IGV, changing the compressor last stage nozzle count, introducing an air redistribution system, or modifying the combustor fuel system, or the like. The means used to address the dynamics issue depends on the driver, or cause, of the problem. Further, these approaches are post mortem, being applied only after an issue is discovered through testing and/or operation of the gas turbine.

### BRIEF DESCRIPTION OF THE INVENTION

According to one aspect of the invention, a combustor includes at least one combustor liner defining a combustion chamber capable of directing combustion products toward a turbine. At least one combustor sleeve is located outside of the combustion chamber and is capable of reducing a magnitude of acoustic waves in the combustion chamber. The at least one combustor liner and the at least one combustor sleeve define at least one flow channel therebetween.

According to another aspect of the invention, a combustor includes at least one combustor liner defining a combustion chamber capable of directing combustion products toward a turbine. At least one combustor sleeve is located outside of the combustion chamber and is capable of controlling distribution of fluid flow in the combustor to modify a uniformity of the fluid flow to the combustion chamber. The at least one combustor liner and the at least one combustor sleeve define at least one flow channel therebetween.

These and other advantages and features will become more apparent from the following description taken in conjunction with the drawings.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a cross-sectional view of an embodiment of a turbomachine;

FIG. 2 is a plan view of an embodiment of a combustor sleeve of the turbomachine of FIG. 1;

FIG. 3 is a plan view of another embodiment of a combustor sleeve of the turbomachine of FIG. 1; and

FIG. 4 is a cross-sectional view of an embodiment of a combustor of the turbomachine of FIG. 1.

The detailed description explains embodiments of the invention, together with advantages and features, by way of example with reference to the drawings.

### DETAILED DESCRIPTION OF THE INVENTION

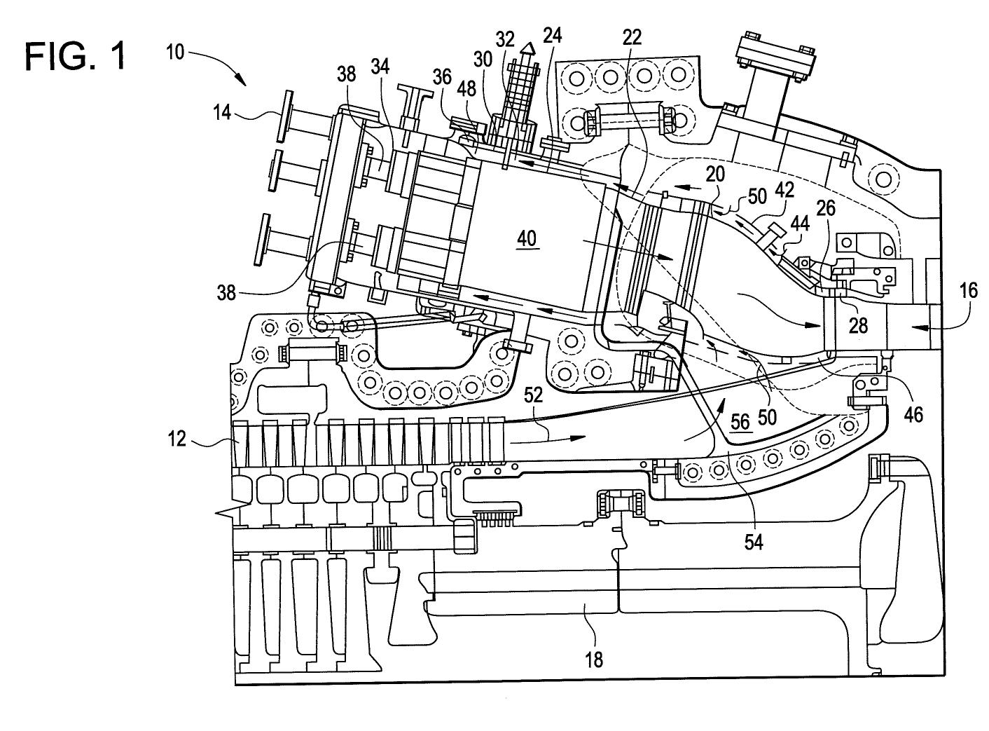

Shown in FIG. 1 is a turbomachine, for example, a gas turbine 10. The gas turbine 10 includes a compressor 12 which provides compressed fluid to a plurality of combustors 14. Fuel is injected into the combustor 14, mixes with the compressed air and is ignited. The hot gas product of the combustion flows to a turbine 16 which extracts work from the hot gas to drive a rotor shaft 18 which in turn drives the compressor 12. The plurality of combustors 14 may be arranged circumferentially around the rotor shaft 18, and in some embodiments may number 10 or 14 combustors 14. A transition piece 20 is coupled at an upstream end 22 to the combustor 14 at a combustor liner 24 and at a downstream end 26 to an aft frame 28 of the turbine 16. The transition piece 20 carries hot gas flow from the combustor liner 24 to the turbine 16. The combustor 14 includes a combustor sleeve 30 spaced radially outward from the combustor liner 24 defining a combustor flow channel 32 therebetween. A combustor cap 34 is coupled to an upstream end 36 of the combustor liner 24 and includes at least one nozzle 38 disposed therein an extending into a combustion chamber 40 defined by the combustor cap 34 and the combustor liner 24. An impingement sleeve 42 is coupled to the combustor sleeve 30 and is radially spaced from the transition piece 20 defining a transition flow channel 44 therebetween. The impingement sleeve 42 includes a plurality of apertures 50 through which flow is introduced into the transition flow channel 44. The transition flow channel 44 extends from a turbine end 46 at the turbine 16 to a head end 48 at the combustor cap 34.

Flow, as identified by arrows 52, proceeds from the compressor 12, through a diffuser 54 and into a compressor discharge chamber 56. The flow 52 exiting the compressor 12 includes dynamic variations such as acoustic waves caused in some instances by a blade passing frequency phenomena. The flow 52 passes through the transition flow channel 44 and enters the combustion chamber 40 for combustion. During operation of the compressor 12, pulses of the acoustic waves may be propagated downstream from the compressor 12 toward the combustor 14. Acoustic waves in the flow 52 which reach the combustor 14 may negatively impact combustion efficiencies, increase emissions and/or damage hardware in the gas turbine 10. In the combustion chamber 40, thermo-acoustic effects such as turbulent flow, chemical reaction instability and vortex shedding can be attributed to pressure and temperature variations in flow 52 in the combustion chamber 40. Further, because of the large amount of energy released in the combustion process, any nonuniformity in the flow 52 is easily amplified by the combustion process. Combustion issues such as lean blowout, dynamics and emissions are also highly sensitive to local fuel/air ratios in the combustion chamber 40, which variation is caused at least in part by nonuniformity of flow 52 at the head end 48 of the combustion chamber 40.

The impingement sleeve 42 as shown in FIG. 1, acts as a damper to reduce the magnitude of the acoustic waves entering the combustion chamber 40. In some embodiments, the plurality of apertures 50 are configured and disposed to shield the combustor liner 24 and transition piece 20 from the acoustic waves. As the flow 52 passes through the plurality of apertures 50, the flow 52 is contracted as it enters each aperture 50, expands as it exits each aperture 50, and impinges on the transition piece 20 and/or the combustor liner 24. The contraction, expansion, and impingement of the flow 52 dampens the acoustic waves. Further, a portion of the flow 52, after passing through apertures 50, proceeds circumferentially around the combustor 14 to increase uniformity of flow 52 around the circumference of the combustor 14.

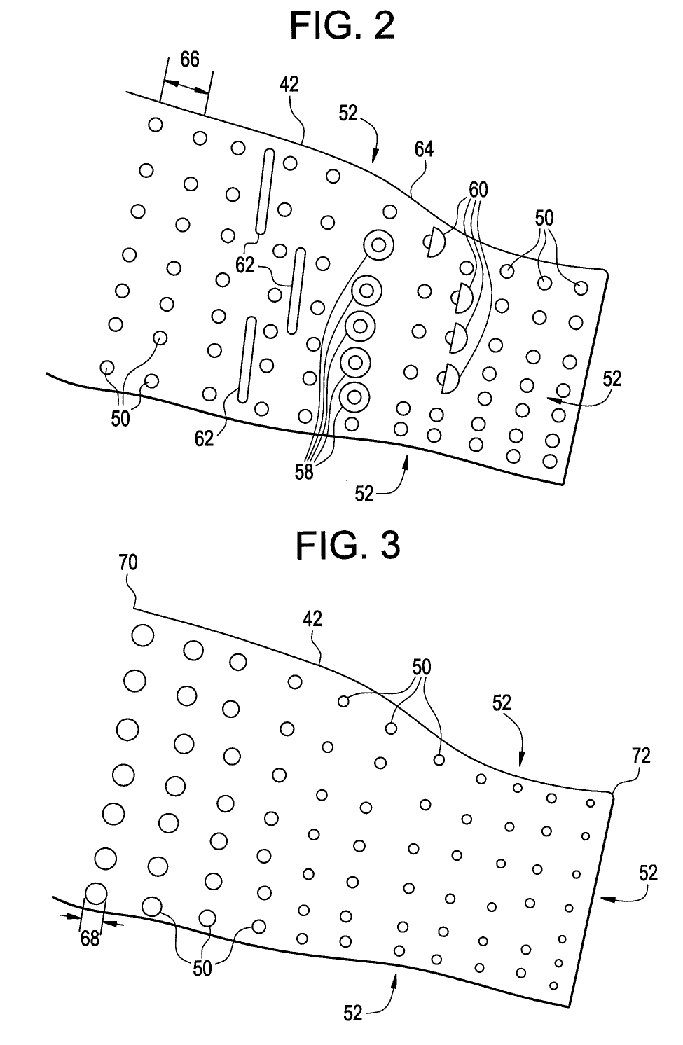

In some embodiments, as shown in FIG. 2, the impingement sleeve 42 includes a plurality of thimbles 58, scoops 60, and/or flow-guiding bars 62, to disrupt flow 52 across an outer surface 64 of the impingement sleeve 42 thus further dampening the acoustic waves.

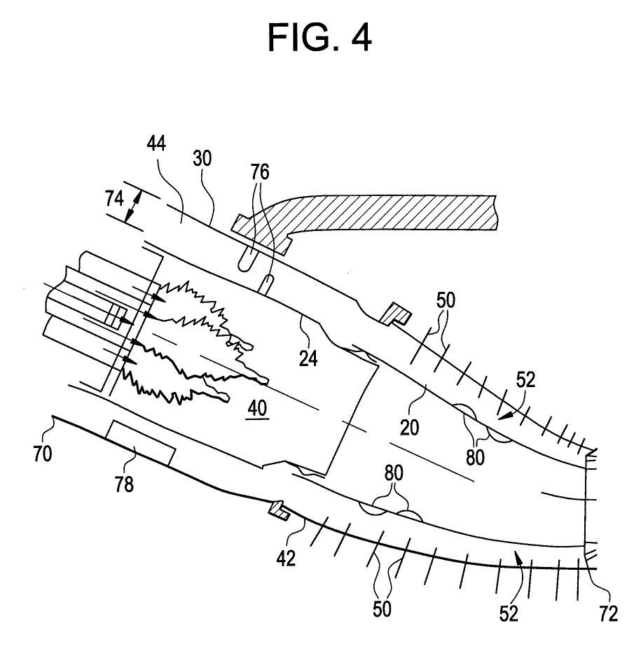

In some embodiments, the plurality of apertures 50 varies in configuration to establish a substantially constant impedance of acoustic waves to enhance dampening of the acoustic waves. As shown in FIG. 2, the plurality of apertures 50 may vary in size and shape at the impingement sleeve 42. In some embodiments, a spacing 66 between apertures 50 of the plurality of apertures 50 is varied, either in one or more localized areas or generally about the impingement sleeve 42. As shown in FIG. 2, these variations may be utilized separately or in combination to increase dampening of desired frequencies. In some embodiments, as shown in FIG. 3, an aperture size 68 of apertures 50 is larger for apertures 50 at a downstream end 70 of the impingement sleeve 42 than an aperture size 68 of apertures 50 disposed at an upstream end 72 of the impingement sleeve 42. In the embodiment shown in FIG. 4, aperture size 66 increases as apertures 46 are disposed closer to the downstream end 70. This enables an increase in a zone of constant impedence in flow 52 through the transition flow channel 44.

In some embodiments, as shown in FIG. 4, a width 74 of the transition flow channel 44 varies from the downstream end 70 to the upstream end 72. This variation enables further increase in the zone of constant impedence in flow 52 through the transition flow channel 44.

Regarding FIG. 4, the combustor liner 24 and or the transition piece 20 may include one or more ribs 76, fins 78, dimples 80, surface roughness (not shown), and/or other like features which increase diffusion, mixing, and redistribution of airflow to increase or decrease uniformity of flow 52 at the downstream end 70 of the transition flow channel 44 which enters the combustion chamber 40. Provision of the plurality of apertures 50 and other enhancements described above are an effective means for damping acoustic waves entering the combustor 14 from the compressor 12 and also increasing uniformity of flow 52 entering the combustor 14.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A combustor comprising:
at least one combustor liner defining a combustion chamber directing combustion products toward turbomachinery; and
at least one impedance sleeve disposed outside of the combustion chamber reducing a magnitude of acoustic waves in the combustion chamber, the at least one combustor liner and the at least one impedance sleeve defining at least one flow channel therebetween.

2. The combustor of claim 1 wherein the at least one impedance sleeve includes a plurality of impedance apertures which direct fluid flow into the at least one flow channel.

3. The combustor of claim 2 wherein fluid flow through the plurality of impedance apertures impinges on the at least one combustor liner to dampen the acoustic waves.

4. The combustor of claim 2 wherein the plurality of impedance apertures dampen the acoustic waves by contracting the fluid flow therethrough.

5. The combustor of claim 2 wherein a spacing between apertures of the plurality of impedance apertures is varied to increase reduction of the magnitude of acoustic waves at desired frequencies.

6. The combustor of claim 2 wherein a size of apertures of the plurality of apertures is varied.

7. The combustor of claim 6 wherein the size of apertures increases from an upstream end to a downstream end of the combustor sleeve.

8. The combustor of claim 1 including at least one flow disruptor disposed at an outer surface of the impedance sleeve.

9. The combustor of claim 8 wherein the at least one flow disruptor comprises at least one of a thimble, scoop, or a flow-guiding bar.

10. The combustor of claim 1 including a plurality of flow diffusers disposed therein.

11. The combustor of claim 10 wherein the plurality of flow diffusers include one or more of a rib, a fin, a dimple, or surface roughness.

12. A combustor comprising:
at least one combustor liner defining a combustion chamber directing combustion products toward turbomachinery; and
at least one impedance sleeve disposed outside of the combustion chamber controlling distribution of fluid flow in the combustor to modify a uniformity of the fluid flow to the combustion chamber, the at least one combustor liner and the at least one impedance sleeve defining at least one flow channel conveying an impedance flow therebetween.

13. The combustor of claim 12 wherein modifying the uniformity of the fluid flow is increasing or decreasing the uniformity of the fluid flow.

14. The combustor of claim 12 wherein the at least one impedance sleeve includes a plurality of apertures capable of directing the impedance flow into the at least one flow channel.

15. The combustor of claim 14 wherein the impedance flow through the plurality of apertures impinges on the at least one combustor liner.

16. The combustor of claim 14 wherein a spacing between apertures of the plurality of apertures is varied.

17. The combustor of claim 14 wherein a size of apertures of the plurality of apertures is varied.

18. The combustor of claim 12 including at least one flow disruptor disposed at an outer surface of the impedance sleeve.

19. The combustor of claim 18 wherein the at least one flow disruptor comprises at least one of a thimble, a scoop, or a flow-guiding bar.

20. The combustor of claim 12 wherein a plurality of flow diffusers including one or more of a rib, a fin, a dimple, or a surface roughness, is disposed therein.
